(19) United States
(12) Patent Application Publication
(10) Pub. No.: US 2003/0161514 A1
(43) Pub. Date: Aug. 28, 2003

(54) Bi-directional scanner control system

(76) Inventor: Bo U. Curry, Redwood City, CA (US)

Correspondence Address: Agilent Technologies, Inc., Legal Department, Intellectual Property Administration, P.O. Box 7599, Loveland, CO, 80537-0599, US

(21) Appl. No.: 10/087,220

(22) Filed: Feb. 28, 2002

(51) Int. Cl. G06K 9/00; G06F 19/00

(52) U.S. Cl. 382/128; 702/20

(57) ABSTRACT

An optical scanning system under specialized feedback control is disclosed. The scanner is adapted for microarray scanning. The control algorithm accounts for tilt in successive scans in opposite directions across a microarray slide or substrate. The feedback approach may involve PI or a PID terms. In either type of control approach, the integral term controlling focusing is artificially set to the negative of its value at the end of a preceding line scan at the start of the next line scan. Depending on the physical configuration of the system, it may be feasible to simply take the negative of the integral term measured by the system. In variations of the invention, integral terms accounting for other focus system variables are taken into account. In practice, marked improvement in scanner focus has been observed by the subject system and included methodology.

### FIELD OF THE INVENTION

This invention relates to optical scanners and, more particularly, to servomechanism focus control involved in bi-directional routines.

### BACKGROUND OF THE INVENTION

Optical scanners find use in performing detection for various experiments, assays and the like. They are often used in array analysis systems for detection of surface bound binding complexes in genomic and proteomic applications.

In performing scans, a typical approach is to zigzag across a microarray slide or substrate obtaining data in a raster fashion. In doing so, it has been appreciated that very slight variation in the tilt or angle of a slide to be scanned must be accounted for in order to achieve acceptable focus on successive features to accurately obtain data.

For this purpose, known systems actuate a scanning lens assembly or the cradle/caddy carrying a slide by servomechanism(s) to bring features into focus by varying the distance between the items. Known feedback logic controllers are used to accomplish this goal.

Two common types of electronic feedback controllers are Proportional-Integral (PI) and Proportional-Integral-Derivative (PID) controllers. The implementation of each may vary widely. Tuning and custom design of each type are well within the ability of those with ordinary skill in the art.

The tuning required to make a selected control system suitable for a given application involves scaling the contribution to the control output of each component of the controller selected. The proportional component(s) of either type of controller operates to direct corrective action to a control element based on the present state of a given process relative to a desired setpoint. Integral component(s) operate by directing control action based on the sum of previous errors in the process. The error sum tends toward zero (and thus a desired state for a given process) as negative error conditions subtract from a positive error total or vice versa due to corrective action taken. Derivative components in a PID controller direct corrective action in response to a change in slope or sign of a measured error condition. As the derivative of a measured value is taken, this term is keyed to rate of change of a process. Implementations of derivative control features include use in making larger or stepwise corrections as well as damping out system oscillations.

In electronic controllers as described, the measure of a given corrective effect in relation the corrective input is understood in terms of control element gain. The controller's bias represents the control effort required to maintain the process at its setpoint absent external loading of the system.

With this understanding of the relevant controller types in mind, certain considerations in array scanning should be appreciated as background to the present invention. Namely, in typical array scanner systems, a lens is scanned back-and-forth across a slide or substrate, while a control algorithm attempts to hold focus by maintaining the distance between a lens and slide despite asymmetries present in the system. Without the teaching of the present invention, however, if the slide being scanned is steeply tilted with respect to the lens (i.e., the left side of the slide is nearer the lens than the right side, or vice versa), the inherent delays of an applicable PI or PID control algorithm cause the actual slide position to lag behind its setpoint/in-focus position. The integral term of the PI or PID control equation attempts to make up for this lag by, in effect, anticipating that the recently observed slope will continue and acting accordingly.

Generally, in a PID controller:

Vₒᵤₜ(t)=kₚe(t)+kᵢI(t)+k_{d}D(t) [1]

where Vₒᵤₜ(t) is the servo control voltage output at time step t, e(t) is the position error measured at time t, I(t) is the running sum of e(t), from t=0 until t, D(t) is the derivative of e(t) and kₚ, kᵢ, and k_{d} are tuning parameters. In a PI system, there is no derivative term. In either type of system, additional terms may be included to further refine matters or provide additional functionality. Other related control equations are well known in the art as well.

During scanning of a sloped surface (i.e., a surface with a distance from the focused lens that increases or decreases substantially monotonically as the scan progresses), the I(t) term in equation [1] (the “integral” term—discussed below in terms of “I” alone in connection with the present invention) will grow until it reaches a value which corrects for the amount the error changes between the time it is measured and the time the control voltage takes effect.

When the scanner reverses direction and begins scanning left-to-right instead of right-to-left (or vice versa), the direction of the slope that the integral term compensates for reverses. Since the integral term continues to add to its running sum, it will eventually adapt to the new tilt direction, and the controller will again control without error. However, in known systems, for a brief period at the start of the reversed scan line (the time until the integral term has time to adapt), the system will not be able to correct for the control loop lag, and may actually exacerbate the error. This usually causes noticeable focus errors for the first few millimeters of each scan line.

In the event significant borders or edge portions are provided around a scan area of a slide that are situated across from the lens assembly during the full motion of the system and the system is allowed to adapt to changing slope as it turns around, the system would be in focus upon returning to the region of interest. However, it is common practice to maximize array sizing/placement on a slide or substrate, leaving no room for purely adaptive control to provide accurate focus.

The present invention corrects for transient focus error—even in systems where no significant slide areas are provided to allow a control algorithm to continue functioning past the target zone so it will adapt to proper focus after turning around and reentering the target zone. Such an improvement provides a significant advantage in light of typical array configurations. In addition, those with skill in the art may well appreciate further utility and advantages in connection with the present invention that are not explicitly stated herein.

### SUMMARY OF THE INVENTION

The system of the present invention is suited for optical scanning under the specialized conditions involved in scanning arrays in raster fashion. In a most basic variation of the invention, the negative of a preceding PI or PID integral term (I_{forward}) for effecting servo focus is used to artificially (as opposed to adaptively) set the focus of a lens upon return to a scan area for scanning a succeeding row. In a more refined variation of the invention, an additional integral term (I_{resting}) accounting for the bias required to hold a constant distance between the lens and a caddy or holder while turning around for the array is considered. In this variation, upon beginning to scan another row the integral term accounting for tilt or slope is set to the sum of this resting value and the negative of its previous integral value accounting for slope which is equivalent to I_{forward}-I_{resting}.

The present invention includes the subject methodology, programming defining the same, hardware configured to run according to the methodology and results or data produced according to the teachings of the present invention.

### BRIEF DESCRIPTION OF THE DRAWINGS

Each of the figures diagrammatically illustrates aspects of the invention. To facilitate understanding, the same reference numerals have been used (where practical) to designate similar elements that are common to the figures.

FIG. 1 is a perspective view of an array package including a substrate carrying a typical array, as may be used in the present invention.

FIG. 2 is an enlarged view of a portion of FIG. 1 showing some of the identifiable individual regions of the array of FIG. 1.

FIG. 3 is a grossly enlarged cross-section of a portion of FIG. 2;

FIG. 4 is a front view of another array package in the form of a cartridge, which may be used in the present invention;

FIG. 5 schematically illustrates an apparatus as may be used in the present invention.

FIG. 6A shows a scan of an array slide or substrate using known techniques; FIG. 6B shows a scan of the same item conducted according to the present invention.

### DETAILED DESCRIPTION OF THE INVENTION

In describing the invention in greater detail than provided in the Summary above, suitable hardware for use with the invention is first described, followed by the subject methodology and suitable algorithm(s) and a discussion of array use. Finally, an example of a specific implementation of the invention is disclosed.

Before the present invention is described in such detail, however, it is to be understood that this invention is not limited to particular variations set forth and may, of course, vary. Various changes may be made to the invention described and equivalents may be substituted without departing from the true spirit and scope of the invention. In addition, many modifications may be made to adapt a particular situation, material, composition of matter, process, process act(s) or step(s), to the objective(s), spirit or scope of the present invention. All such modifications are intended to be within the scope of the claims made herein.

Methods recited herein may be carried out in any order of the recited events which is logically possible, as well as the recited order of events. Furthermore, where a range of values is provided, it is understood that every intervening value, between the upper and lower limit of that range and any other stated or intervening value in that stated range is encompassed within the invention. Also, it is contemplated that any optional feature of the inventive variations described may be set forth and claimed independently, or in combination with any one or more of the features described herein.

All existing subject matter mentioned herein (e.g., publications, patents, patent applications and hardware) is incorporated by reference herein in its entirety except insofar as the subject matter may conflict with that of the present invention (in which case what is present herein shall prevail). The referenced items are provided solely for their disclosure prior to the filing date of the present application. Nothing herein is to be construed as an admission that the present invention is not entitled to antedate such material by virtue of prior invention.

Reference to a singular item, includes the possibility that there are plural of the same items present. More specifically, as used herein and in the appended claims, the singular forms “a,” “and,” “said” and “the” include plural referents unless the context clearly dictates otherwise. It is further noted that the claims may be drafted to exclude any optional element. As such, this statement is intended to serve as antecedent basis for use of such exclusive terminology as “solely,” “only” and the like in connection with the recitation of claim elements, or use of a “negative” limitation.

Unless defined otherwise below, all technical and scientific terms used herein have the same meaning as commonly understood by one of ordinary skill in the art to which this invention belongs. Still, certain elements are defined herein for the sake of clarity.

A “biopolymer” is a polymer of one or more types of repeating units. Biopolymers are typically found in biological systems and particularly include polysaccharides (such as carbohydrates), peptides (which term is used to include polypeptides and proteins) and polynucleotides as well as their analogs such as those compounds composed of or containing amino acid analogs or non-amino acid groups, or nucleotide analogs or non-nucleotide groups. This includes polynucleotides in which the conventional backbone has been replaced with a non-naturally occurring or synthetic backbone, and nucleic acids (or synthetic or naturally occurring analogs) in which one or more of the conventional bases has been replaced with a group (natural or synthetic) capable of participating in Watson-Crick type hydrogen bonding interactions. Polynucleotides include single or multiple stranded configurations, where one or more of the strands may or may not be completely aligned with another. A “nucleotide” refers to a sub-unit of a nucleic acid and has a phosphate group, a 5 carbon sugar and a nitrogen containing base, as well as functional analogs (whether synthetic or naturally occurring) of such sub-units which in the polymer form (as a polynucleotide) can hybridize with naturally occurring polynucleotides in a sequence specific manner analogous to that of two naturally occurring polynucleotides. Biopolymers include DNA (including cDNA), RNA, oligonucleotides, and PNA and other polynucleotides as described in U.S. Pat. No. 5,948,902 and references cited therein (all of which are also incorporated herein by reference), regardless of the source. An “oligonucleotide” generally refers to a nucleotide multimer of about 10 to 100 nucleotides in length, while a “polynucleotide” includes a nucleotide multimer having any number of nucleotides. A “biomonomer” references a single unit, which can be linked with the same or other biomonomers to form a biopolymer (e.g., a single amino acid or nucleotide with two linking groups one or both of which may have removable protecting groups).

An “array,” includes any two-dimensional or substantially two-dimensional arrangement of addressable regions bearing a particular chemical moiety or moieties (e.g., biopolymers such as polynucleotide sequences (nucleic acids), polypeptides (e.g., proteins), etc.) associated with that region. In the broadest sense, the preferred arrays are arrays of polymeric binding agents, where the polymeric binding agents may be any of: polypeptides, proteins, nucleic acids, polysaccharides, synthetic mimetics of such biopolymeric binding agents, etc. In many embodiments of interest, the arrays are arrays of nucleic acids, including oligonucleotides, polynucleotides, cDNAs, mRNAs, synthetic mimetics thereof, and the like. Where the arrays are arrays of nucleic acids, the nucleic acids may be covalently attached to the arrays at any point along the nucleic acid chain, but are generally attached at one of their termini (e.g. the 3′ or 5′ terminus). Sometimes, the arrays are arrays of polypeptides, e.g., proteins or fragments thereof.

An array is “addressable” when it has multiple regions of different moieties (e.g., different polynucleotide sequences) such that a region (i.e., a “feature” or “spot” of the array) at a particular predetermined location (i.e., an “address”) on the array will detect a particular target or class of targets (although a feature may incidentally detect non-targets of that feature). Array features are typically, but need not be, separated by intervening spaces. In the case of an array, the “target” will be referenced as a moiety in a mobile phase (typically fluid), to be detected by probes (“target probes”) which are bound to the substrate at the various regions. However, either of the “target” or “target probe” may be the one which is to be evaluated by the other (thus, either one could be an unknown mixture of polynucleotides to be evaluated by binding with the other). A “scan region” refers to a contiguous (preferably, rectangular) area in which the array spots or features of interest, as defined above, are found. The scan region is that portion of the total area illuminated from which the resulting fluorescence is detected and recorded. For the purposes of this invention, the scan region includes the entire area of the slide scanned in each pass of the lens, between the first feature of interest, and the last feature of interest, even if there exist intervening areas which lack features of interest. An “array layout” refers to one or more characteristics of the features, such as feature positioning on the substrate, one or more feature dimensions, and an indication of a moiety at a given location. “Hybridizing” and “binding”, with respect to polynucleotides, are used interchangeably.

By “remote location,” it is meant a location other than the location at which the array is present and hybridization occurs. For example, a remote location could be another location (e.g., office, lab, etc.) in the same city, another location in a different city, another location in a different state, another location in a different country, etc. As such, when one item is indicated as being “remote” from another, what is meant is that the two items are at least in different rooms or different buildings, and may be at least one mile, ten miles, or at least one hundred miles apart. “Communicating” information references transmitting the data representing that information as electrical signals over a suitable communication channel (e.g., a private or public network). “Forwarding” an item refers to any means of getting that item from one location to the next, whether by physically transporting that item or otherwise (where that is possible) and includes, at least in the case of data, physically transporting a medium carrying the data or communicating the data. An array “package” may be the array plus only a substrate on which the array is deposited, although the package may include other features (such as a housing with a chamber). A “chamber” references an enclosed volume (although a chamber may be accessible through one or more ports). It will also be appreciated that throughout the present application, that words such as “top,” “upper,” and “lower” are used in a relative sense only.

A “processor” references any hardware and/or software combination which will perform the functions required of it. For example, any processor herein may be a programmable digital microprocessor such as available in the form of a electronic controller, mainframe, server or personal computer (desktop or portable). Where the processor is programmable, suitable programming can be communicated from a remote location to the processor, or previously saved in a computer program product (such as a portable or fixed computer readable storage medium, whether magnetic, optical or solid state device based). For example, a magnetic medium or optical disk may carry the programming, and can be read by a suitable reader communicating with each processor at its corresponding station.

Hardware

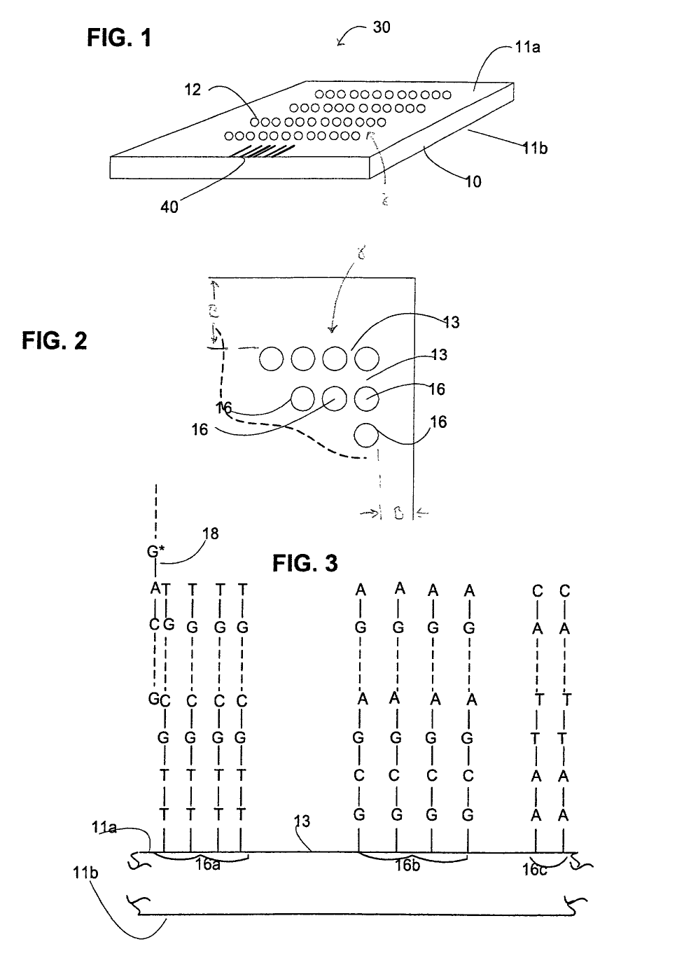

Turning now to the figures, FIGS. 1-3 show an array in the form of a contiguous, substantially planar substrate 10 that carries multiple features 16 disposed across a first surface 11a of substrate 10 separated by interfeature areas 13. The substrate is preferably made of transparent material to facilitate data acquisition scanning therethrough. Alternatively, the substrate could be scanned from the side which carries the array. Features 16 are shown disposed in a pattern which defines the array. The extent of the pattern defines the scan region 8. A second surface 11b of substrate 10 does not carry any features. Substrate 10 may be of any shape although the remainder of any package carrying substrate 10, and the apparatus of the present invention, may need to be adapted accordingly.

A typical array usually includes at least two distinct polymers that differ by monomeric sequence immobilized on (i.e., covalently or non-covalently attached to) different and known locations on the substrate surface, where a space between each location or feature may or may not be present. Each distinct polymeric sequence of the array is typically present as a composition of multiple copies of the polymer on the substrate surface (e.g. as a spot or feature 16 on the surface of the substrate). The number of distinct polymeric sequences, and hence features 16, present on the slide or substrate may vary, but is generally at least 10, where the number may be as high as at least 50, 100, 500, 1000 or 10,000. The density of features present on the array surface may vary, but will generally be at least about 10 and usually at least about 100 spots/cm², where the density may be as high as 10⁶ or higher, but will generally not exceed about 10⁵ spots/cm².

While all of the features 16 may be of different composition, some could be the same (e.g., when any repeats of each feature composition are excluded the remaining features may account for at least 5%, 10%, or 20% of the total number of features). In any event, each feature carries probes in the form of a one moiety or mixture of moieties, which in the case of each feature 16 in FIGS. 1-3 is preferably a polynucleotide having a particular sequence, while interfeature areas 13 do not carry any moieties of a type the same as the features 16 (i.e., no polynucleotides in the case of features 16 carrying polynucleotides).

Such an array configuration is illustrated schematically in FIG. 3 where regions 16 are shown as carrying different polynucleotide sequences. Features 16 may have widths (that is, diameter, for a round spot) of at least 5 or 10 μm, and usually less than 1.0 cm. In embodiments where very small spot sizes or feature sizes are desired, each of the features 16 may have widths of at least 1.0 μm and less than 1.0 mm, usually less than 500 μm, and more usually less than 200 μm. Features that are not round may have areas equivalent to the area ranges of round features 16 resulting from the foregoing diameter ranges. The probes of features 16 are typically linked to substrate 10 through a suitable linker (not shown).

The array 12 may cover an area of less than 100 cm², or even less than 50, 10 or 1 cm. In many embodiments, substrate 10 will be shaped generally as a rectangular solid (although other shapes are possible), having a length of more than 4 mm and less than 1 m, usually more than 4 mm and less than 600 mm, more usually less than 400 mm; a width of more than 4 mm and less than 1 m, usually less than 500 mm and more usually less than 400 mm; and a thickness of more than 0.01 mm and less than 5.0 mm, usually more than 0.1 mm and less than 2 mm and more usually more than 0.2 and less than 1 mm.

Usually, borders “B” around scan region 8 less than about 5-15 mm are provided. It is often desirable to lay down features as close to the edge of the substrate as possible so as to maximize the number of different probes that may be displayed on a given surface area. As such, in many array configurations, the width of a border, if present, does not exceed about 20 mm, usually does not exceed about 10 mm and more usually does not exceed about 5 mm.

An array identifier 40 in the form of a bar code in FIG. 1, is associated with the array 12, by being provided on the same substrate 10 adjacent one of the arrays 12. In the case where more than one array 12 is present on the same substrate 10, a separate identifier can be provided adjacent each corresponding array 12 if desired. Identifier 40 may either contain information on the layout of array 12 or be linkable to a file containing such information in a manner such as described in U.S. Pat. No. 6,180,351. Each identifier 40 for different arrays may be unique so that a given identifier will likely only correspond to one array 12 or to a plurality of arrays 12 on a given substrate 10. This configuration can be accomplished by making identifier 40 sufficiently long and incrementing or otherwise varying it for different arrays 12 or arrays 12 on the same substrate 10, or even by selecting it to be globally unique in a manner in which globally unique identifiers are selected as described in U.S. Pat. No. 6,180,351.

Arrays such as those of FIGS. 1-3 can be fabricated using drop deposition from pulse-jets of either polynucleotide precursor units (such as monomers) in the case of in situ fabrication, or a previously obtained polynucleotide. Such methods are described in detail in, for example, the previously cited references including U.S. Pat. Nos. 6,242,266, 6,232,072, 6,180,351, 6,171,797, 6,323,043, U.S. patent application Ser. No. 09/302,898 filed Apr. 30, 1999 by Caren, et al., and the references cited therein. Other drop deposition methods can be used for fabrication, as well. Also, instead of drop deposition methods, other array fabrication method may be used including pin spotting and the techniques described in U.S. Pat. Nos. 5,599,695, 5,753,788, and 6,329,143.

Inter-feature areas 13 need not be present particularly when the arrays are made by light directed methods as described in those patents. In use, a feature can detect a polynucleotide of a complementary sequence by hybridizing to it, such as polynucleotide 18 being detected by feature 16a in FIG. 3 (the “*” on polynucleotide 18 indicating a label such as a fluorescent label). Use of arrays to detect particular moieties in a sample (such as target sequences) are well known. The layer thickness of the probes at features 16, together with any detected target to which they are bound, is often less than 500 nm thick, and often less than 200, 100, 50 or 20 nm in thickness.

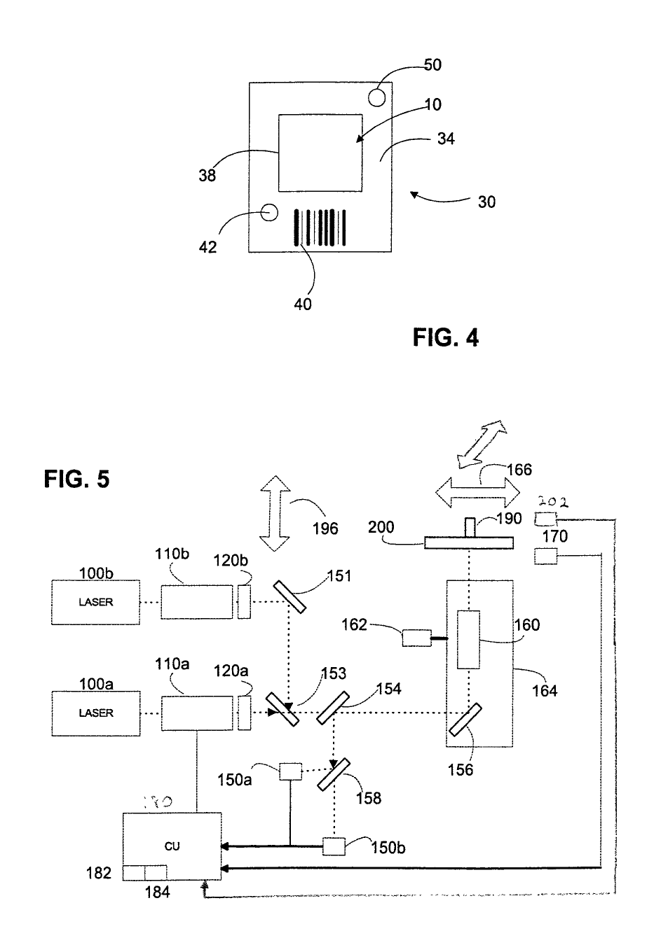

Referring now to FIG. 4 an array package 30 may include a housing 34 which has received substrate 10 adjacent an opening. Substrate 10 is sealed (such as by the use of a suitable adhesive) to housing 34 around a margin 38 with the second surface 11b facing outward. Housing 34 is configured such that housing 34 and substrate 10, define a chamber into which features 16 of array 12 face. This chamber is accessible through resilient septa 42, 50 which define normally closed ports of the chamber. In this case, array package 30 may be associated with the identifier 40 by providing identifier 40 on housing 34. Such association of any these or other items with the array, can be accomplished, for example, by the items being present in the same package as the array when shipped to an end user.

The components of the embodiments of either array package 30 described above, may be made of any suitable material. For example, housing 34 can be made of metal or plastic such as polypropylene, polyethylene or acrylonitrile-butadienestyrene (“ABS”). Substrate 10 may be of any suitable material, and is preferably sufficiently transparent to the wavelength of an interrogating and array emitted light, as to allow interrogation from its underside whether situated in a housing 34 or not. Such transparent and non-transparent materials include, for flexible substrates: nylon, both modified and unmodified, nitrocellulose, polypropylene, and the like. For rigid substrates, specific materials of interest include: glass; fused silica, silicon, plastics (e.g., polytetrafluoroethylene, polypropylene, polystyrene, polycarbonate, and blends thereof, and the like); metals (e.g., gold, platinum, and the like).

The first surface 11a of substrate 10 may be modified with one or more different layers of compounds that serve to modify the properties of the surface in a desirable manner. Such modification layers, when present, will generally range in thickness from a monomolecular thickness to about 1 mm, usually from a monomolecular thickness to about 0.1 mm and more usually from a monomolecular thickness to about 0.001 mm. Modification layers of interest include: inorganic and organic layers such as metals, metal oxides, polymers, small organic molecules and the like. Polymeric layers of interest include layers of: peptides, proteins, polynucleic acids or mimetics thereof (for example, peptide nucleic acids and the like); polysaccharides, phospholipids, polyurethanes, polyesters, polycarbonates, polyureas, polyamides, polyethyleneamines, polyarylene sulfides, polysiloxanes, polyimides, polyacetates, and the like, where the polymers may be hetero- or homopolymeric, and may or may not have separate functional moieties attached thereto (for example, conjugated). The materials from which substrate 10 and housing 34 (at least the portion facing toward the inside of chamber 36) may be fabricated should ideally themselves exhibit a low level of binding during hybridization or other events.

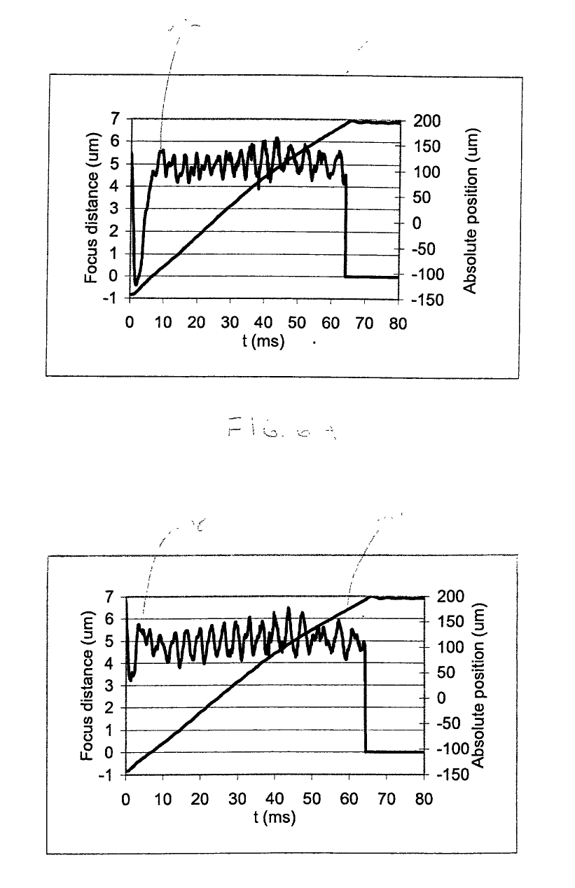

Referring now to FIG. 5, an apparatus of the present invention (which may be generally referenced as an array “scanner”) is illustrated. A light system provides light from a laser 100 which passes through an electro-optic modulator (EOM) 110 with attached polarizer 120. Each laser 100a, 100b may be of different wavelength (e.g., one providing red light and the other green) and each has its own corresponding EOM 110a, 110b and polarizer 120a, 120b. The beams may be combined along a path toward a holder or caddy 200 by the use of full mirror 151 and dichroic mirror 153. A control signal in the form of a variable voltage applied to each corresponding EOM 110a, 110b by the controller (CU) 180, changes the polarization of the exiting light which is thus more or less attenuated by the corresponding polarizer 120a, 120b. Controller 180 may be or include a suitably programmed processor. Thus, each EOM 110 and corresponding polarizer 120 together act as a variable optical attenuator which can alter the power of an interrogating light spot exiting from the attenuator. The remainder of the light from both lasers 100a, 100b is transmitted through a dichroic beam splitter 154, reflected off fully reflecting mirror 156 and focused onto either an array 12 of an array package 30 mounted on holder 200, or a calibration member 230, whichever is at a reading position, using optical components in beam focuser 160. Light emitted (in particular, fluorescence) at two different wavelengths (e.g., green and red light) from features 16, in response to the interrogating light, is imaged using the same optics in focuser/scanner 160, and is reflected off mirrors 156 and 154. The two different wavelengths are separated by a further dichroic mirror 158 and are passed to respective detectors 150a and 150b.

More optical components (not shown) may be used between the dichroic and each detector 150a, 150b (such as lenses, pinholes, filters, fibers, etc.) and each detector 150a, 150b may be of various different types (e.g., a photo-multiplier tube (PMT) or a CCD or an avalanche photodiode (APD)). All of the optical components through which light emitted from an array 12 or calibration member 230 in response to the illuminating laser light, passes to detectors 150a, 150b, together with those detectors, form a detection system. This detection system has a fixed focal plane. A scan system causes the illuminating region in the form of a light spot from each laser 100a, 100b, and a detecting region of each detector 150a, 150b (which detecting region will form a pixel in the detected image), to be scanned across multiple regions of an array or array package 30 mounted on holder 200. The scanned regions for an array 12 will include at least the multiple features 16 of the array. In particular the scanning system is typically a line by line scanner, scanning the interrogating light in a line across an array 12 when at the reading position, in a direction of arrow 166, then moving (“transitioning”) the interrogating light in a direction into/out of the paper as viewed in FIG. 5 to a position at an end of a next line, and repeating the line scanning and transitioning until the entire array 12 has been scanned.

This scanning feature is accomplished by providing a housing 164 containing mirror 158 and focuser 160, which housing 164 can be moved along a line of pixels (i.e., from left to right or the reverse as viewed in FIG. 5) by a transporter 162. The second direction 192 of scanning (line transitioning) can be provided by second transporter which may include a motor and belt (not shown) to move caddy 200 along one or more tracks. The second transporter may use a same or different actuator components to accomplish coarse (a larger number of lines) movement and finer movement (a smaller number of lines). Generally, directly adjacent rows are scanned. However, “adjacent” rows may include alternating rows or rows where more than one intervening row is skipped.

The reader of FIG. 5 may further include a reader (not shown) which reads an identifier 40 from an array package 30. When identifier 40 is in the form of a bar code, that reader may be a suitable bar code reader.

Of course, the movements 166 and 192 may be accomplished by actuating holder 200 or housing 164 alone. Still further, the movement roles described for each element above may be swapped.

An autofocus detector 170 is provided to sense any offset (variation in slope) between different regions of array 12 when in the reading position, and a determined position of the focal plane of the detection system. The autofocus system includes detector 170, processor 180, and a motorized or servo-controlled adjuster 190 to move holder 200 in the direction of arrow 196 to establish correct focus for the system. The detector may directly detect a partial reflection from another beamsplitter (not shown) between splitters 153 and 154. In addition, a second position detector 202, also feeding back to the CU, preferably measures the absolute position (i.e., relative to the apparatus) of the servo-controlled adjuster 190). As above with respect to movements 166 and 192, it should be observed that focus servo control movement 196 may occur in connection with housing 164 instead of the holder. Further details regarding suitable chemical array autofocus hardware is described in pending U.S. patent application Ser. No. 09/415,184 for “Apparatus And Method For Autofocus” by Dorsel, et al., filed Oct. 7, 1999, as well as European publication EP 1091229 published Apr. 11, 2001 to the same title and inventors.

Irrespective of the hardware implementation, the present invention is centrally concerned with the methodology by which lens focus is controlled. Furthermore, array orientation and configuration is of little consequence since focus can be set to features 16 either directly, or looking through a transparent substrate medium if the array is inverted for scanning (for instance, when upper surface 11a is blocked-off with housing features and surface 11b is exposed).

Controller 180 of the apparatus is connected to receive signals from detectors 150a, 150b (these different signals being different “channels”), namely a signal which results at each of the multiple detected wavelengths from emitted light for each scanned region of array 12 when at the reading position mounted in holder 200. Controller 180 also receives the signal from autofocus offset detector 170 and absolute servo position detector 202, and provides the control signal to EOM 110, and controls the scan system. Controller 180 may also analyze, store, and/or output data relating to emitted signals received from detectors 150a, 150b in a known manner.

Controller 180 may include a computer in the form of a programmable digital processor, and include a media reader 182 which can read a portable removable media (such as a magnetic or optical disk), and a communication module 184 which can communicate over a communication channel (such as a network, for example the internet or a telephone network) with a remote site (such as a database at which information relating to array package 30 may be stored in association with the identification 40).

Controller 180 is suitably programmed to execute all of the steps required by it during operation of the apparatus, as discussed further below. Alternatively, controller 180 may be any hardware or hardware/software combination which can execute those steps.

In one mode of operation, the array in package 30 is typically first exposed to a liquid sample. This liquid sample may be placed directly on substrate 10 or introduced into a chamber through one of the septa 42, 50. The array may then be washed and scanned with a liquid (such as a buffer solution) present in the chamber and in contact with the array, or it may be dried following washing. After mounting a given array package 30 in cradle 200 (either with the array features on the glass surface nearer to, or further from, the lens—depending, at least, upon the lens setup) the identifier reader may automatically (or upon operator command) read array ID 40, and use this to retrieve information on the array layout. Such information may be retrieved directly from the contents of identifier 40 when ID 40 contains such information. Alternatively, identifier 40 may be used to retrieve such information from a database containing the identifier in association with such information. Such a database may be a local database accessible by controller 180 (such as may be contained in a portable storage medium in drive 182 which is associated with package 30, such as by physical association with package 30 when received by the user, or by a suitable identification), or may be a remote database accessible by controller 180 through communication module 184 and a suitable communication channel.

The saved results from a sample exposed array, read with focal distances set according to the present invention, may be raw results (such as fluorescence intensity readings for each feature in one or more color channels) or may be processed results such as obtained by rejecting a reading for a feature which is below a predetermined threshold and/or forming conclusions based on the pattern read from the array (such as whether or not a particular target sequence may have been present in the sample). The results of the reading (processed or not) may be forwarded (such as by communication of data representing the results) to a remote location if desired, and received there for further use (such as further processing).

While it is noted that that a bi-directional optical system is disclosed, it is contemplated that scanning in an “opposite” directions may be accomplished in connection with features 16 that are arranged in a series of straight rows or curvilinear rows across the substrate surface. What is required by “bi-directional” scanning is that the relative motion between the lens assembly and array (optionally, a holder too) reverses in direction at the end of scanning a set of features and begins moving in a contrary direction along a substantially parallel path (at least initially) in scanning a near-by row set of features.

Substrate 10 may actually carry more than one array 12, arranged as desired. While substrate 10 is planar and rectangular in form, other shapes may also be used—with optional housing 34 being adjusted accordingly. Still, in many embodiments, substrate 10 will be shaped generally as a planar, rectangular solid, having a length in the range about 4 mm to 200 mm, usually about 12 mm to 150 mm, more usually about 20 mm to 80 mm; a width in the range about 4 mm to 200 mm, usually about 10 mm to 80 mm and more usually about 10 mm to 30 mm; and a thickness in the range about 0.01 mm to 5.0 mm, usually from about 0.1 mm to 2 mm and more usually from about 0.9 to 1.2 mm. However, larger substrates can be used. Additionally, during scanning it is possible to illuminate all pixels of a line simultaneously (for example, by using a line of light emitting diodes).

Methodology

Preferably, the present invention is implemented with a PID control system. However, PI adaptation is adequate for the present invention. It is typically fast enough to keep up with generally slow changes in array substrate tilt that occur during a typical scan line.

In the system of the present invention, it is considered that the integral term of the PI or PID control system can be broken down into a part which functions to anticipate the substrate or slide tilt, and another part which is required to hold position lens or housing 164 in the absence of slide tilt (i.e., it accounts for system bias such as the bearings in the assembly, or other asymmetries in the mechanism such as those associated with nonlinear servo control voltage). The latter (quantifiable) term is referred to as I_{resting}. The former part is referred to as Iₛₗₒₚₑ, but it cannot be isolated or directly measured. For the purposes of the system at hand, it is assumed that the slope changes little from scan line to scan line (but has an opposite sign moving in the opposite direction).

Accordingly, the following equations are considered:

I_{forward}=I_{resting}+Iₛₗₒₚₑ [2]

Iᵣₑᵥₑᵣₛₑ=I_{resting}−Iₛₗₒₚₑ [3]

where I_{forward} is the integral term required to hold focus to a slide with a positive tilt and Iᵣₑᵥₑᵣₛₑ is the integral term required to hold focus when the slide is tilted in the reverse direction (actually, the slide is tilted in the same direction in space, but is scanned in the reverse direction).

Rearranging equation [2]:

Iₛₗₒₚₑ=I_{forward}−I_{resting}. [4]

Substituting equation [4] into equation [3]:

Iᵣₑᵥₑᵣₛₑ=I_{resting}−(I_{forward}−I_{resting}) or 2(I_{resting})−I_{forward}. [5]

At the end of the reverse scan line, the roles of I_{forward} and Iᵣₑᵥₑᵣₛₑ are interchanged to handle subsequent scan line(s) or row(s) and the process is repeated until scanning is complete.

In line with the approach above, the present invention functions to anticipate Iᵣₑᵥₑᵣₛₑ at the beginning of a reverse scan line, without having to adapt to it. I_{forward} is measured at the end of a forward scan line. I_{resting} is preferably measured during turn-around of the lens or array cradle assembly to provide the best approximation of Iᵣₑᵥₑᵣₛₑ that is available.

However, in instances where I_{resting} would be sufficiently low (even negligible), the term may be dropped from equations [2] and [3] thereby producing a simplified approach where these equations are rearranged so:

Iᵣₑᵥₑᵣₛₑ=−I_{forward} [6]

Note, however, that in most cases superior results will be obtained if I_{resting} is not discarded.

However accomplished, after setting the Iᵣₑᵥₑᵣₛₑ value to its predicted value, the servo focus control system (i.e. autofocus system) takes measurements and proceeds as is typical based on the control algorithm selected until the end of the next scan row is reached and the process repeats, running in the opposite direction.

Certain conditions should hold for the invention to operate as intended. Foremost is the alternating direction of scan which results in a change of slope direction appreciated by detector 170. Next, the tilt of the array substrate should vary slowly compared with the integral time constants of the control loop (i.e., the few ms required for the integral term to adapt to changes in surface tilt). Also (as alluded to above), it should be the case that the tilt of the substrate or slide varies little between one scan row or lane and the next. The close proximity of sequential rows (generally between 2 and 20 μm) in a typical array assists in maintaining the validity of this assumption for more-or-less flat substrates.

Most preferably, a system run according to the present invention does not attempt to maintain focus after it travels past the scan region 8 where it finishes scanning a row. Rather, it preferably controls to a constant position as it proceeds past, turns and returns to the scan area. Utilizing this operating protocol avoids erroneous focus “corrections” (that could result from an attempt to maintain focus past the edge of an array substrate, when encountering housing 34 or a bar code). Avoiding such errors provides for a more efficient system.

It is more efficient, in that surface defects or reflective features in regions of the substrate other than the active scan region will not be able to deleteriously affect the quality of the results, as would be the case if one tried (but failed) to control focus outside the scan region. Also, controlling focus outside the scan region would require maintaining use of at least one of the lasers outside the scan region. If the laser were to reflect from a very reflective or fluorescent patch on the holder (such as starched paper in a barcode, or fluorescent glue) the resulting fluorescence intensity could result in irreversible damage to the scanner (namely, its PMT detectors). In the preferred embodiment of the system, the EOMs turn the lasers off while the scanner reverses direction, thus avoiding both autofocus instability and detector damage.

Also, it is noted that the invention may be configured for use in, alternately, 1) a fully adaptable mode or 2) a mode using an artificially set Iᵣₑᵥₑᵣₛₑ value or term as described above. In which case, where an array with sufficiently large borders B are present, conventional PI, PID or a related manner of servo focus control may be utilized to good effect. However, even in instances where the control approach can be selected between a known approach and that of the present invention, it may be desired to set-up the system to use the method of the present invention as its default program to handle the more common array situation.

This being said, it should be appreciated that the present invention has been shown to function with such superb results that little advantage (if any) would be offered by a system that can toggle between approaches. Accordingly, it is most preferred to program a scanning system solely with the subject program methodology.

Array Use

The subject methods and systems find use in a variety of different applications, where such applications are generally arrays based analyte detection applications in which the presence of a particular analyte in a given sample is detected at least qualitatively, if not quantitatively, using an array based protocol. Protocols for carrying out such assays are well known to those of skill in the art and need not be described in great detail here. Generally, the sample suspected of comprising the analyte of interest is contacted with an array under conditions appropriate for the analyte to bind to its respective binding pair member that is present on the array. Thus, if the analyte of interest is present in the sample, it binds to the array at the site of its complementary binding member and a complex is formed on the array surface. The presence of this binding complex on the array surface is then detected, e.g. through use of a signal production system, e.g. an isotopic or fluorescent label present on the analyte, etc. The presence of the analyte in the sample is then deduced from the detection of binding complexes on the substrate surface.

Specific analyte detection applications of interest include hybridization assays in which nucleic acid arrays are employed. In these assays, a sample of target nucleic acids is first prepared, where preparation may include labeling of the target nucleic acids with a label, e.g. a member of signal producing system. Following sample preparation, the sample is contacted with the array under hybridization conditions, whereby complexes are formed between target nucleic acids that are complementary to probe sequences attached to the array surface. The presence of hybridized complexes is then detected. Specific hybridization assays of interest which may be practiced include: gene discovery assays, differential gene expression analysis assays; nucleic acid sequencing assays, and the like. U.S. patent Nos. describing methods of using arrays in various applications include: U.S. Pat. Nos. 5,143,854; 5,288,644; 5,324,633; 5,432,049; 5,470,710; 5,492,806; 5,503,980; 5,510,270; 5,525,464; 5,547,839; 5,580,732; 5,661,028; 5,800,992; the disclosures of which are herein incorporated by reference.

Where the arrays are arrays of polypeptide binding agents, e.g., protein arrays, specific applications of interest include analyte detection/proteomics applications, including those described in: U.S. Pat. Nos. 4,591,570; 5,171,695; 5,436,170; 5,486,452; 5,532,128; and 6,197,599; the disclosures of which are herein incorporated by reference; as well as published PCT application Nos. WO 99/39210; WO 00/04832; WO 00/04389; WO 00/04390; WO 00/54046; WO 00/63701; WO 01/14425; and WO 01/40803; the disclosures of the United States priority documents of which are herein incorporated by reference.

As noted above, in certain embodiments, the subject methods include a step of transmitting data from at least one of the detecting and deriving steps, as described above, to a remote location. The data may be transmitted to the remote location for further evaluation and/or use. Any convenient telecommunications means may be employed for transmitting the data, (e.g., facsimile, modem, internet, etc.)

As such, the array will typically be exposed to a sample (e.g., a fluorescently labeled analyte such as a protein containing sample) and the array then read. Reading of the array may be accomplished by illuminating the array and reading the location and intensity of resulting fluorescence at each feature of the array to detect any binding complexes on the surface of the array. For example, a scanner may be used for this purpose which is similar to the AGILENT MICROARRAY SCANNER available from Agilent Technologies, Palo Alto, Calif. Other suitable apparatus and methods are described in U.S. patent application Ser. No.: 09/846,125 “Reading Multi-Featured Arrays” by Dorsel, et al.; and Ser. No. 09/430,214 “Interrogating Multi-Featured Arrays” by Dorsel, et al. As previously mentioned, these references are incorporated herein by reference as are all other references cited herein.

Results from the reading may be raw results (such as fluorescence intensity readings for each feature in one or more color channels) or may be processed results such as obtained by rejecting a reading for a feature which is below a predetermined threshold and/or forming conclusions based on the pattern read from the array (such as whether or not a particular target sequence may have been present in the sample). The results of the reading (processed or not) may be forwarded (such as by communication) to a remote location if desired, and received there for further use (such as further processing).

The following examples are offered by way of illustration and not by way of limitation. It is evident from the results obtained thereby and discussion above that the subject invention provides a number of benefits, which benefits include more accurate array reading, even with arrays having little or no border regions. As such, the subject invention represents a significant contribution to the art.

### EXAMPLE

The AGILENT MICROARRAY SCANNER referenced above utilizes a PID type controller run according to the present invention. In doing so, the methodology described herein is generally applied according to the following tuned equation:

Vₒᵤₜ(t)=kₚe(t)+kᵢI(t)+k_{d}D(t) [1]

where Vₒᵤₜ(t) is the servo control voltage output at time step t to actuate focus control motion 196 (in volts), e(t) is the position error measured at time t (in μm), I(t) is the running sum of e(t), from t=0 until t (in μm-seconds), D(t) is the derivative of e(t) (in μm/sec), and kₚ, kᵢ, and k_{d} are tuning parameters, where kₚ=0.15 V/μm, kᵢ=25 V/μm/sec, and k_{d}=−8×10⁻⁵ V-sec/μm. The values of these tuning parameters and such other terms as may be used are easily derived and implemented using standard control system tuning techniques to account for the particular scanner system hardware configuration at issue.

In use, the present invention operates so scan lines are substantially in focus or exactly in focus immediately upon reentry of a scan region 8. This is a marked improvement over the few millimeters or more of focus error common in most known systems.

FIGS. 6A and 6B, respectively, present comparative results of scanning a slide with a known system and one operating according to the present invention. In an otherwise identical setup, a lens assembly set with a focus distance of +5 μm (relative to an arbitrary zero) scans the slide at 1 m/sec, so one ms on the time axis represents 1 mm of distance along the slide.

The traces shown in each figure correspond to a single scan line beginning when the lens moves into the scan area, moving from right to left. At about 64 ms (after scanning 6.4 cm), the lens leaves the scan area and stops controlling the focus. Here, the scanning stage is slowing down, in preparation to turn around and scan back in the opposite direction. The lasers used for detection are turned off at this point, so the measured focus position drops to zero.

The diagonal line 204 from lower left to upper right in both figures is the absolute position of the slide (relative to the bench), as measured by detector 202, and refers to the right vertical axis. As the autofocus controller maintains focus, it moves the assembly about 350 μm, in order to compensate for the tilt of the slide. Note that the slide also has a slight bow, but is mostly straight. Also note, that the focus position controller is not perfectly tuned, so that the actual focus position oscillates around its setpoint of 5 μm in traces 206 and 208 as read using the left vertical axis of the graphs.

In running the scan with known methodology, about 10 ms of scan (i.e., 10 mm) pass before there is no appreciable focus bias. This result is shown by plot or trace 206 in FIG. 6A. The focus error observed during this period is much larger than its steady-state value. The error is a reflection of the time required for the PID controller to adapt its integral term to track the tilt of the slide. When the scanner reverses direction and begins scanning again, this transient error will appear as a similar magnitude positive error instead of the negative error observed.

When controlling the focus according to the present invention, the initial transient is greatly reduced. This result is shown by plot or trace 208 in FIG. 6B. With the present invention, the focus error experienced in this setup never exceeds its +/−2 μm maximum error specification. This is little more than the steady-state system oscillation and less than half the error presented by the purely adaptive focus approach shown in FIG. 6A. After the first 10 ms, the traces 206 and 208 are similar as the integral term of the controller adapts to the continuing slope of the slide.

In this example of the practice of the invention, I_{resting} is recorded at the very beginning of the displayed trace, whereupon Iᵣₑᵥₑᵣₛₑ is computed and activated. The I_{forward} value that is also used to compute the Iᵣₑᵥₑᵣₛₑ term is taken from a preceding scan line, recorded at the point where the focus signal drops to 0 (about 64 ms)—just as shown in FIGS. 6A and 6B.

Though the invention has been described in reference to certain examples, optionally incorporating various features, the invention is not to be limited to the set-ups described. The invention is not limited to the uses noted or by way of the exemplary description provided herein. It is to be understood that the breadth of the present invention is to be limited only by the literal or equitable scope of the following claims. That being said,

I claim:

1. A method of scanning an array, said method comprising:
providing an optical scanner system comprising a processor and a scanning lens assembly;
providing an array opposite said scanning lens assembly, said array comprising a substrate and a plurality of array features;
scanning a first row with said lens assembly, utilizing an adaptive control algorithm to maintain focus on said array features in said first row by accounting for a slope of said substrate;
calculating an I_{forward} integral term up to or near an end of said first row;
reversing scan direction to scan a second, adjacent row; and
initially using the negative of said I_{forward} term to set a focus of said lens assembly at a start of scanning said second row.

2. The method of claim 1, wherein motion of a caddy carrying said array sets said focus.

3. The method of claim 1, wherein a position of said lens assembly is held substantially constant relative to a caddy carrying said array from a termination of scanning said first row to said start of scanning said second row.

4. The method of claim 1, further comprising calculating an I_{resting} term, wherein two times the value of said I_{resting} term is added to said I_{forward} term at said start of scanning said second row to set said focus.

5. The method of claim 1, wherein said adaptive control algorithm is a PI algorithm.

6. The method of claim 1, wherein said adaptive control algorithm is a PID algorithm.

7. The method of claim 1 carried out in reading a biopolymer array.

8. The method of claim 7, wherein the biopolymer is selected from the group consisting of polypeptides and nucleic acids.

9. The method of claim 8, further comprising:
wherein said method further comprises a data transmission step in which a result from a reading of the array is transmitted from a first location to a second location.

10. The method of claim 9, where said second location is a remote location.

11. A method comprising receiving data representing a result of a reading obtained by the method of claim 9.

12. A system programmed to operate according to a method selected from a group consisting of the scanning methods of claims 1-11.

13. A computer-readable medium embodying a program to direct a scanner system to perform a method selected from a group consisting of the scanning methods of claims 1-11.

14. A computer-readable medium containing data representing array sample results, wherein said data is made by a method selected from a group of methods consisting of the optical scanning methods of claims 1-11.

15. An optical scanner system comprising:
a processor and a lens assembly positioned opposite an array caddy; and
a plurality of servo mechanisms to control a relative position of said lens assembly and said caddy in three axes;
wherein said processor is adapted to control focus of said lens for sequential opposite-direction scans on array features situated on an array substrate to be carried by said caddy, by utilizing the negative of a forward integral term at an end of a scan region accounting for a forward slope of said substrate as a reverse integral term accounting for a reverse slope of said substrate upon reentering said scan region.

16. The system of claim 15, wherein at least one servo mechanism controlling said caddy manipulates said focus.

17. The system of claim 15, wherein said adaptation comprises a PI type adaptive algorithm.

18. The system of claim 15, wherein said adaptation comprises a PID type adaptive algorithm.

19. The system of claim 15, wherein said integral term is I_{forward}.

20. The system of claim 15, wherein said system is further adapted to hold a substantially constant position of said lens assembly relative to said caddy between said opposite direction scans.

21. The system of claim 20, wherein said system is further adapted to measure a bias required to hold said substantially constant position, and said system is also adapted to use two times a bias integral term, based on said bias, to set focus for said reverse slope.

22. The system of claim 21, wherein said bias integral term is I_{resting}.

23. The system of claim 15, wherein said system further comprises a biopolymer array.

24. The system of claim 23 wherein the biopolymer array is selected from the group consisting of a polypeptide array and a nucleic acid array.
